(19) United States
(12) Patent Application Publication
(10) Pub. No.: US 2013/0038464 A1
(43) Pub. Date: Feb. 14, 2013

(54) Acoustic Telemetry System for Use in a Drilling BHA

(71) Applicants: Laurent Alteirac, Nesoya (NO); Erwann Lemenager, Paris (FR)

(72) Inventors: Laurent Alteirac, Nesoya (NO); Erwann Lemenager, Paris (FR)

(21) Appl. No.: 13/261,393

(22) PCT Filed: Jan. 27, 2011
(86) PCT No.: PCT/EP11/51152

§ 371 Date: Nov. 2, 2012

(30) Foreign Application Priority Data
Feb. 4, 2010 (EP) 10152704.2

(51) Int. Cl. G01V 3/00

(52) U.S. Cl. 340/854.4

(57) ABSTRACT

A system for transmitting data along a borehole, comprises a drill string; a bottom hole assembly connected to the drill string including a drilling motor powered by flow of fluid from the drill string, a drill bit connected below the drilling motor and arranged to be rotated by the motor, and at least one sensor being positioned between the drilling motor and the drill bit; a first telemetry system for transmitting data from a first location below the drilling motor to a second location above the drilling motor, the first telemetry system comprising a first transmitter at the first location configured to induce an acoustic signal for propagation along the BHA, and a first acoustic receiver at the second location arranged to receive the acoustic signal; and a second telemetry system comprising two or more transmission channels for transmitting data received by the first acoustic receiver from the second location back up the borehole. The transmission channels are selectable based on a measured condition of the borehole.

### TECHNICAL FIELD

This invention relates to a telemetry system for transmitting data from a downhole drilling assembly to the surface of a well. In particular the invention relates to an acoustic telemetry system for data transmission during drilling operations.

### BACKGROUND ART

Drilling operations are typically conducted using a bottom hole assembly (BHA) connected to a drill string that runs from the surface of the well. The BHA typically comprises a number of functional elements, including the drill bit, a motor to drive the drill bit in certain operations, sensors, and data acquisition and telemetry sections. Data is transmitted to and from the BHA by means of a telemetry system that passes data along the borehole.

During drilling operations it is often desirable to determine parameters such as the direction and inclination of the drill bit so that the BHA can be steered in the correct direction. Sensors can also record measurements that will be used for interpretation once retrieved at surface. In such operations, the operator can greatly benefit from having reliable real-time communication between the surface and downhole.

The presence of the motor can provide a number of limitations on such systems. Because of the manner in which drilling motors operate, their need to generate sufficient power, and the need to locate the motor close to the drill bit, there is usually insufficient space below the motor to locate sensors and telemetry systems to communicate data back up the well for real time measurements to be made. However, it is desirable to have certain sensors as close to the bit as possible, particularly where these are to be used for making decisions relating to drilling direction.

It can be difficult to provide such communication using a cable all the way from the bottom of the borehole to the surface since its presence inside the tubing string it limits the flow diameter and requires complex structures to pass the cable from the inside to the outside of the tubing. A cable inside the tubing is also an additional complexity in case of emergency disconnect for an offshore platform. Space outside the tubing is limited and the cable can easily be damaged. Therefore wireless telemetry systems are preferred in such measurement while drilling operations.

A number of proposals have been made for wireless telemetry systems based on acoustic communication. Examples of this can be found in US2007/0257809, US2008/0056067, U.S. Pat. No. 6,909,667, U.S. Pat. No. 7,068,183, U.S. Pat. No. 7,158,446, U.S. Pat. No. 7,301,473, U.S. Pat. No. 7,324,010, U.S. Pat. No. 7,339,494, and WO00/77345.

However the presence of vibrations in the tubing of the drill string due to the drilling process can affect the detection of signals transmitted along the tubing. Typically the quality of the signal reaching the surface is measured in terms of signal to noise ratio. As the ratio drops it become more difficult to recover or reconstruct the signal. In acoustic telemetry, energy can be lost out of the frequency bandwidth of interest, leading to low signal to noise ratio.

It is an object of this invention to provide a system that can transmit acoustic signal in a controlled way into order to minimize signal losses and improve telemetry performance across the mud motor so as to allow real-time measurements to be made closer to the drill bit. The invention is based on the use of multiple telemetry systems that are optimized for particular situations.

### DISCLOSURE OF THE INVENTION

A first aspect of the invention provides a system for transmitting data along a borehole, comprising:
a drill string;
a bottom hole assembly (BHA) connected to the drill string including a drilling motor powered by flow of fluid from the drill string, a drill bit connected below the drilling motor and arranged to be rotated by the motor, and at least one sensor being positioned between the drilling motor and the drill bit;
a first telemetry system for transmitting data from a first location below the drilling motor to a second location above the drilling motor, the first telemetry system comprising a first transmitter at the first location configured to induce an acoustic signal for propagation along the BHA, and a first acoustic receiver at the second location arranged to receive the acoustic signal; and
a second telemetry system comprising two or more transmission channels for transmitting data received by the first acoustic receiver from the second location back up the borehole, wherein the channels are selectable according to a measured signal to noise ratio of the channels.

Where a rotary steerable unit is provided between the drilling motor and the drill bit, the acoustic transmitter can be located in the rotatable steerable unit.

The second telemetry system can comprise a second acoustic transmitter and a second acoustic receiver for transmitting and receiving signals along the drill string. The second telemetry system can also comprise an electromagnetic telemetry system.

The sensor can comprise one or more sensors to monitor downhole parameters and configured to transmit data to the first acoustic transmitter.

A second aspect of the invention comprises a method for transmitting signals along a borehole from a sensor in a bottom hole assembly (BHA) connected to a drill string and including a drilling motor powered by flow of fluid from the drill string, a drill bit connected below the drilling motor and arranged to be rotated by the motor, and the sensor being positioned between the drilling motor and the drill bit, the method comprising:
receiving data from the sensor at a first acoustic transmitter located between the drill bit and the drilling motor;
configuring the data into an acoustic signal;
transmitting the acoustic signal from the first acoustic transmitter along the BHA to a first acoustic receiver located above the drilling motor;
communicating the signal to a second telemetry system comprising two or more transmission channels;
selecting a channel according to the measured signal to noise ratio of the channels; and
transmitting the signal along the borehole via the selected channel of the second telemetry system.

The step of transmitting the acoustic signal via the second telemetry system can comprise transmitting the signal as an acoustic signal or as an electromagnetic signal.

Further aspects of the invention will be apparent from the following description.

### BRIEF DESCRIPTION OF THE DRAWINGS

The invention will now be described by way of example with reference to the accompany drawings:

FIG. 1 shows a schematic view of an acoustic telemetry system according to an embodiment of the invention.

### MODE(S) FOR CARRYING OUT THE INVENTION

The invention is based on the use of short hop acoustic telemetry to transmit data across the drilling motor of a bottom hole drilling assembly.

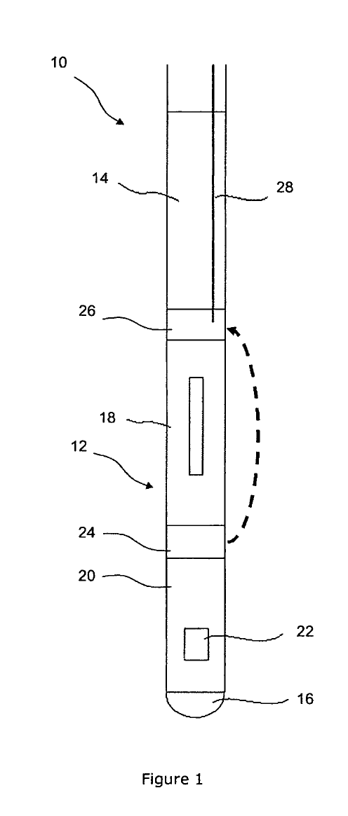

FIG. 1 shows a schematic view of such a system. The example of FIG. 1 shows a drilling system 10 having a BHA 12 positioned at the lower end of a drill string 14 that extends from the wellhead equipment at the surface (not shown). The BHA comprises a drilling motor (typically a mud motor/Moyno motor) 18 and a rotary steerable unit 20 arranged to drive a drill bit 16. Sensors 22 are incorporated into the BHA to record and measure parameters of the borehole.

An acoustic telemetry transmitter 24 is located below the motor 18 and above the drill bit 16. The transmitter can comprise a piezoelectric stack or a magnetostrictive stack which can be driven to generate an acoustic signal in the tubing of the BHA.

The acoustic transmitter 24 is in communication with the sensors 22 of the BHA. The acoustic transmitter 24 receives a signal from the sensors 22. Such signals are typically digital signals which are then converted to an acoustic signal. The sensors are selected to measure such downhole parameters such as downhole pressures, temperatures, downhole flow rates, resistivity or conductivity of the drilling mud or earth formations, density and porosity of the earth formations and other downhole conditions, using known techniques.

An acoustic receiver 26 is located above the motor 18 in the BHA 12 to receive the signal transmitted by the acoustic transmitter 24. The material of the BHA forms an acoustic transmission channel between the acoustic transmitter 24 and the acoustic receiver 26. The acoustic receiver 26 can comprise an accelerometer or piezoelectric stack.

A second telemetry system is provided to transfer the signal received by the acoustic receiver 26 along the drill string, typically to the surface. The second telemetry system provides more than one transmission channel which can transfer the signal along the drill string. The transmission channel to be used is selectable according to a measured condition of the channels, such as the signal to noise ratio. The acoustic receiver 26 is coupled to a local telemetry bus 28 of the BHA which is used to provide data communication between the various functional elements of the BHA. The acoustic receiver 26 detects the acoustic signal passing along the BHA from the transmitter 24. The detected signal is applied to receiver electronics which operate to generate an electrical signal that can be transmitted to the local telemetry bus 28. The local telemetry bus transfers the signal to the electronics in the BHA for controlling the second telemetry system. Examples of the transmission channels of the second telemetry system include mud-pulse telemetry of the type commonly used in MWD systems, electrical cables, electromagnetic telemetry systems, and further acoustic telemetry systems. The second telemetry system will be selected according to the broad requirements of the drilling operation and is independent of the first, acoustic telemetry system.

In use, measurements are made by the sensors 22 and the data is collected, compressed and transformed into an acoustic signal by the acoustic transmitter 24. The acoustic signal propagates along the material of the BHA across the motor 18 to the acoustic receiver 26 which detects the acoustic signal passing along the BHA.

The acoustic receiver 26 processes the received acoustic signal and communicates the processed signal to the local telemetry bus 28. The signal to noise ratio of each of the channels of the second telemetry system is measured. Based on the measured signal to noise ratio, the transmission channel with the most favorable signal to noise ratio in response to the downhole conditions is selected. The processed signal is transferred to the surface by the selected transmission channel of the second telemetry system.

The telemetry system is described above with reference to transmitting measurements up to the surface. However during drilling operations instructions may be sent downhole from the surface, i.e. instruction for a change in direction of drilling. Acknowledgement of these orders, along with downhole measurements relating to the change in direction if required, can be fed back to the surface using the second telemetry system.

Data from the sensor 22 can also be stored in the system for retrieval at some later time. Data storage can take place near the sensor or in the BHA above the motor. Stored data can be downloaded when the BHA is retrieved from the borehole, or by running a cable along the drill string to the BHA (this may constitute the second telemetry system).

The invention provides a means by which data can be communicated across the drilling motor without the need to run electrical data connections though the motor section. Thus data can be collected below the motor, closer to the bit than in many LWD or MWD systems and from a location where mud pulse telemetry or electromagnetic telemetry can be difficult or impossible. During drilling operations, the presence of vibrations in the drill string due to the drilling process can affect the detection of acoustic signals transmitted along the drill string. Using the short hop acoustic telemetry to transmit the signal across the mud motor minimises signal losses and helps improve telemetry performance across the mud motor. The second telemetry system can be optimised for longer distance communication that takes into account the drilling system and its characteristics. Providing a number of possible transmission channels and selecting one of the transmission channels to transmit the signal along the drill string, allows a suitable channel to be used according to the conditions encountered downhole. This can help improve the transmission of the signal over longer distances.

Further modifications within the scope of the invention will be apparent. For example, the system described above considers data communication to the surface. It will be appreciated that the benefit of the invention is equally obtained where the data communication is to a point below the surface but well-removed from the BHA. The drill string can comprise any form of drill string currently used for such drilling operations, whether drill pipe, coiled tubing, casing, or any other form of drill string.

1. A system for transmitting data along a borehole, comprising:
a drill string;
a bottom hole assembly connected to the drill string including a drilling motor powered by flow of fluid from the drill string, a drill bit connected below the drilling motor and arranged to be rotated by the motor, and at least one sensor being positioned between the drilling motor and the drill bit;
a first telemetry system for transmitting data from a first location below the drilling motor to a second location above the drilling motor, the first telemetry system comprising a first transmitter at the first location configured to induce an acoustic signal for propagation along the BHA, and a first acoustic receiver at the second location arranged to receive the acoustic signal; and
a second telemetry system comprising two or more transmission channels for transmitting data received by the first acoustic receiver from the second location back up the borehole wherein the channels are selectable according to the measured signal to noise ratio of the channels.

2. A system as claimed in claim 1, wherein a rotary steerable unit is provided between the drilling motor and the drill bit, the acoustic transmitter being located in the rotatable steerable unit.

3. A system as claimed in claim 1 or 2, wherein the second telemetry system comprises a second acoustic transmitter and a second acoustic receiver for transmitting and receiving signals along the drill string.

4. A system as claimed in claim 1 or 2, wherein the second telemetry system comprises an electromagnetic telemetry system.

5. A system as claimed in any preceding claim, wherein the sensor comprises one or more sensors to monitor downhole parameters and configured to transmit data to the first acoustic transmitter.

6. A method for transmitting signals along a borehole from a sensor in a bottom hole assembly connected to a drill string and including a drilling motor powered by flow of fluid from the drill string, a drill bit connected below the drilling motor and arranged to be rotated by the motor, and the sensor being positioned between the drilling motor and the drill bit, the method comprising:
receiving data from the sensor at a first acoustic transmitter located between the drill bit and the drilling motor;
configuring the data into an acoustic signal;
transmitting the acoustic signal from the first acoustic transmitter along the BHA to a first acoustic receiver located above the drilling motor;
communicating the signal to a second telemetry system comprising two or more transmission channels;
selecting one of the channels according to the measured signal to noise ratio of the channels; and
transmitting the signal along the borehole via the selected channel of the second telemetry system.

7. A method as claimed in claim 6, wherein the step of transmitting the acoustic signal via the second telemetry system comprises transmitting the signal as an acoustic signal or as an electromagnetic signal.

8. A method as claimed in claim 6 or 7, wherein the bottom hole assembly forms part of a system as claimed in any of claims 1-5.
